(19) United States
(12) Patent Application Publication
(10) Pub. No.: US 2008/0102670 A1
(43) Pub. Date: May 1, 2008

(54) DUAL-HINGE ACCESSORY TO MOUNT CONNECTOR AND ASSEMBLY

(76) Inventor: Thomas E. DERECKTOR, Portsmouth, RI (US)

Correspondence Address: PILLSBURY WINTHROP SHAW PITTMAN, LLP, P.O. BOX 10500, MCLEAN, VA, 22102, US

(21) Appl. No.: 11/554,803

(22) Filed: Oct. 31, 2006

(51) Int. Cl. H01R 13/62

(52) U.S. Cl. 439/160

(57) ABSTRACT

A mounting assembly for attaching an object to a rail is provided that includes a mount that is configured to mount to the rail. The mount has a first connector receiving portion. The assembly includes an object having a second connector receiving portion and a connector having a first end portion configured to be received by the first connector receiving portion and to rotate, with respect to the mount, about an axis substantially parallel to the longitudinal axis of the rail. The connector also has a second end portion configured to be received by the second connector receiving portion and to rotate, with respect to the object, about an axis substantially parallel to the longitudinal axis of the rail. The connector is free to rotate such that, within a range of motion, horizontal movements of the object transfer substantially no horizontal forces to the mount.

### FIELD OF THE INVENTION

The present invention relates to mounting assemblies and, more particularly, to a mounting assembly that reduces binding effects.

### BACKGROUND OF THE INVENTION

Conventional truck bed accessories are typically attached to rail tracks by sliding a slotted mount over an end of a track. The mount and accessory are then slid along the track until they reach their final position. Due to nonconformities in the vehicle, rail, or track, however, sliding mounts may run into problems such as, for example, binding, derailment, or blockage. In cases where accessories have two mounts coupled thereto, each sliding onto opposite rails on a truck bed, a small defect may result in the rails becoming nonparallel and cause the accessory mounts to bind, preventing attachment.

### SUMMARY OF THE INVENTION

In accordance with an aspect of the present invention, a mounting assembly is provided for attaching an object to a rail. The rail has a longitudinal axis and the mounting assembly includes a mount that is configured to mount to the rail. The mount has a first connector receiving portion and an object has a second connector receiving portion. A connector has a first end portion configured to be pivotally received by the first connector receiving portion and to pivot, with respect to the mount, about an axis essentially parallel to the longitudinal axis of the rail. The connector further has a second end portion configured to be pivotally received by the second connector receiving portion and to pivot, with respect to the object, about an axis essentially parallel to the longitudinal axis of the rail. The connector is free to pivot such that, within a range of motion, lateral movements of the object transfer substantially no lateral forces to the mount.

In accordance with another aspect of the present invention a method is provided for attaching an object to a rail having a longitudinal axis. A mount is mounted to a rail and has a first connector receiving portion. A first end portion of a connector is slid into the first connector receiving portion and a second end portion of the connector is slid into a second connector receiving portion attached to the object. The connector is free to pivot relative to the mount and relative to the object, within a range, about an axis essentially parallel to the longitudinal axis of the rail.

In accordance with another aspect of the present invention a system for attaching an object between a pair of rails is provided. The rails have essentially parallel longitudinal axes and the system comprises an object and a first mounting assembly. The first mounting assembly includes a first mount configured to mount to a first of the rails for longitudinal movement along the first rail. The first mount is connected to a first lateral side of the object. The system further includes a second mounting assembly that includes a second mount configured to mount to a second of the rails for longitudinal movement along the second rail. The second mount has a first connector receiving portion. A second connector receiving portion is connected to a second lateral side of the object. A connector has a first end portion that is configured to be pivotally received by the first connector receiving portion and to pivot, with respect to the second mount, about an axis essentially parallel to the rails. The connector further has a second end portion configured to be pivotally received by the second connector receiving portion and to pivot, with respect to the object, about an axis essentially parallel to the axes of the rails. The connector is free to pivot such that, within a range of motion, lateral movement of the object transfers substantially no lateral forces to the second mount.

In accordance with another aspect of the present invention a mounting assembly for attaching an object to a rail is provided. The rail has a longitudinal axis and the mounting assembly includes a mount configured to mount to the rail. The mount has a first connector receiving portion and an object has a second connector receiving portion. A connector has a first end portion configured to be received by the first connector receiving portion and a second end portion configured to be received by the second connector receiving portion. The connector is constructed to permit lateral movement between the mount and the object within a range of motion such that the object transfers substantially no lateral forces to the mount.

Other objects, features, and advantages of the present invention will become apparent from the following detailed description, the accompanying drawings, and the appended claims.

### BRIEF DESCRIPTION OF THE DRAWINGS

The above-mentioned and other features and advantages of this disclosure, and the manner of attaining them, will become more apparent and the disclosure itself will be better understood by reference to the following description taken in conjunction with the accompanying drawings, wherein:

FIG. 1 is a side view of a mounting assembly in accordance with an embodiment of the present invention;

FIG. 2 is a perspective view of a mounting assembly in accordance with an embodiment of the present invention;

FIG. 3 is an exploded view illustrating various parts of a mounting assembly in accordance with an embodiment of the present invention;

FIG. 4 is a side view of a portion of a mounting assembly in a first position in accordance with an embodiment of the present invention;

FIG. 5 is a side view of a portion of a mounting assembly in a second position in accordance with an embodiment of the present invention;

FIG. 6 is a side view of a mount portion of a mounting assembly in accordance with an embodiment of the present invention;

FIG. 7 is a perspective view of an object having an end surface in accordance with an embodiment of the present invention; and

FIG. 8 is a perspective view of a truck bed having a rail in accordance with an embodiment of the present invention.

An embodiment will be described with reference to the accompanying drawings. Corresponding reference characters indicate corresponding parts throughout the several views. The description as set out herein illustrates an arrangement of an embodiment of the present disclosure and is not to be construed as limiting its scope in any manner.

### DETAILED DESCRIPTION OF THE INVENTION

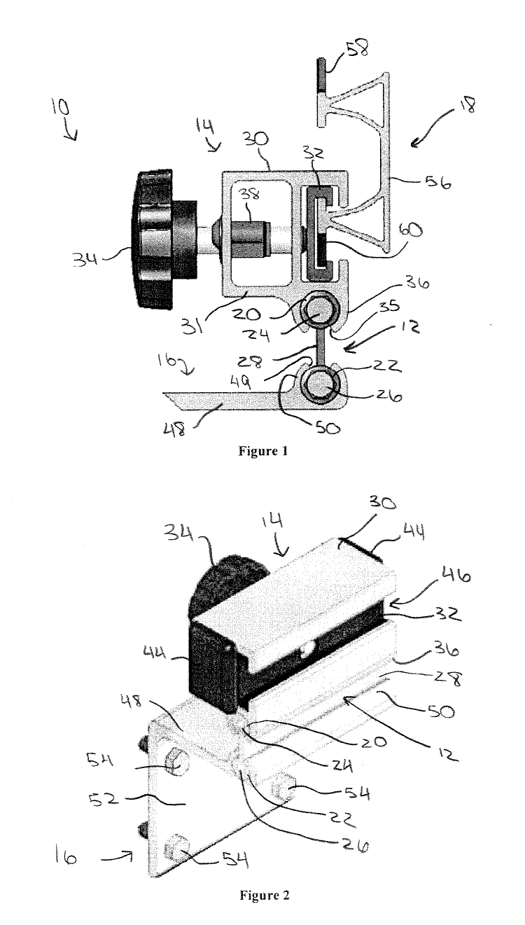

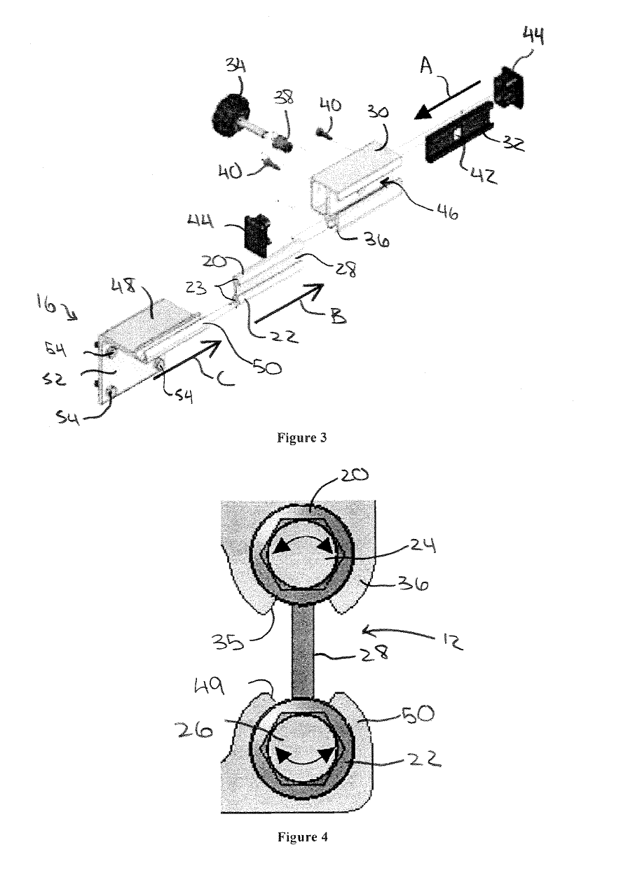

The present invention discloses a dual-hinge connector and attachment assembly. As shown generally in FIGS. 1, 2, and 3, a mounting assembly 10 may include a rail 18, a mount 14, an object 16 for mounting, and a connector 12. The rail 18 may be a permanent installation or removable accessory on a vehicle or other carrying structure, such as a truck bed 100 shown in FIG. 8. As shown, the truck bed 100 includes side panels 110 and tailgate panel 120, each having rails 18 installed thereon. The rails 18 may be of a “T-track” type that has one, two, or several attachment tracks 58, 60 for receiving a mount 14 and extend in a longitudinal direction along an axis perpendicular to the cross-sectional plane shown in FIG. 1. Conventional mounts for attachment to such rails typically have slots that are slid longitudinally onto the rail tracks at each of their respective ends. The conventional mount is then slid along the track until it reaches its final location.

In accordance with a mounting assembly 10 in accordance with the present invention, a mount 14 may be slid onto one or more of the tracks 58, 60 of the rail 18 from a longitudinal end of the rail 18. Alternatively, the mount 14 may be transversely attached to the rail 18 at any location thereof. In such embodiments, a mount frame 30 may be manipulated around a track 60 such that the track 60 is in a space 46 defined by a C-shaped portion of the mount frame 30, as described in co-pending U.S. patent application Ser. No. 11/554,758, filed Oct. 31, 2006, which is hereby incorporated by reference in its entirety. A liner 32 may be slid into position between the track 60 and the mount frame 30 so as to take up any excess space. A tightening knob 34 and nut 38 or other locking mechanism (e.g., a set screw) may be used to maintain the position of the mount 14 along the track 60.

End caps 44 may be inserted into respective longitudinal ends of the mount frame 30 and secured by fasteners 40 in order to further hold the mount in place and to block access to the interior of the frame 30, e.g., for safety, aesthetic, or other purposes.

The mount frame 30 has a lower surface 31 that includes a connector receiving portion 36. In the embodiment shown, the connector receiving portion 36 has a generally tubular configuration and has a cutaway portion or slit 35 extending substantially along the length of the connector receiving portion 36. Thus the connector receiving portion 36 may be characterized as having a general C-shape.

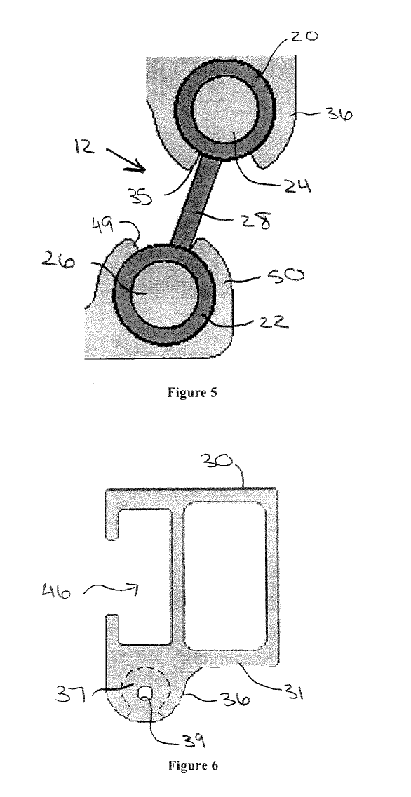

As shown in FIG. 6, the connector receiving portion 36 may have at one end an axial end surface 37. The end surface 37 may be a generally flat surface that extends perpendicularly to the longitudinal axis of the tubular connector receiving portion 36. The end surface 37 may be used to define an end position for a connector 12 or for securing a connector 12, as described below. The end surface 37 may include a hole 39, which may or may not be threaded, for use in securing a connector 12 thereto.

An object 16 to be attached to the mount 14 may be an accessory, a mounting bracket that is secured to an accessory, or some other object that is desired to be attached to a mount 14 mounted on a track 58 or 60. As shown in the Figures, object 16 is a mounting bracket for attachment to an accessory, such as a tool box or other accessory. The object 16 may include an attachment surface 52 for attachment to an accessory with bolts 54. Any other attachment structure for securing the object 16 to an accessory may be used, and the illustrated construction is not intended to be limiting. Likewise, the object 16 may be part of or integral with the accessory.

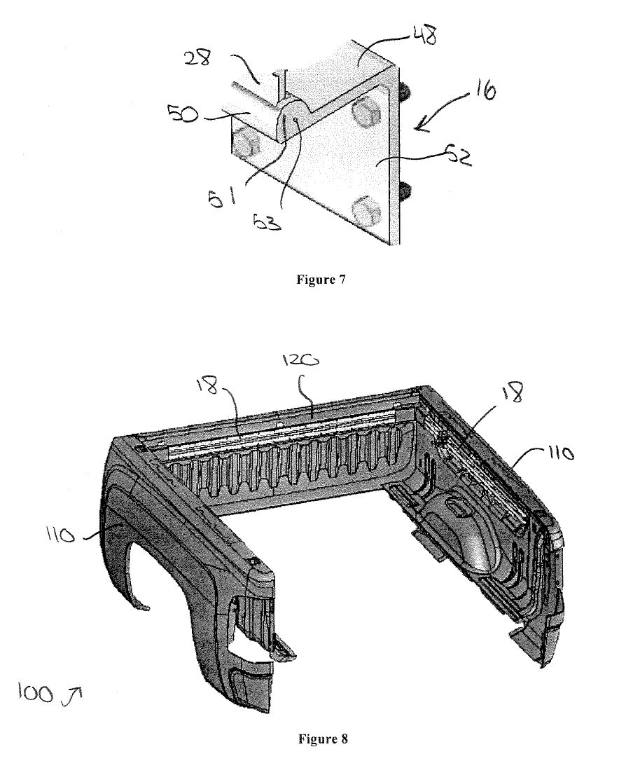

The object 16 may further include a top surface 48 having thereon a connector receiving portion 50 similar to the connector receiving portion 36 on the mount frame 30. The connector receiving portion 50 on the object is likewise generally tubular and C-shaped but instead has a cutaway or slit 49 on a top portion thereof, whereas the connector receiving portion 36 on the frame 30 has a slit 35 on a lower portion thereof. As shown in FIG. 7, one end of the tubular connector receiving portion may include an end surface 51 that generally extends perpendicular to a longitudinal axis of the tubular connector receiving portion 50. The end surface 51 may be used to define an end position for a connector 12 or for securing a connector 12, as described below. The end surface 51 may include a hole 53, which may or may not be threaded, for use in securing a connector 12 thereto.

As shown in FIG. 4, the connector 12 may include a first cylindrical end portion 20, a second cylindrical end portion 22, and flange 28 extending between the first and second cylindrical end portions 20, 22. The connector 12 may be formed of extruded or molded metal, plastic, or other suitable material. In one embodiment, the connector 12 extends in a longitudinal direction, parallel to the longitudinal axis of the rail, for a length of about 4 to about 8 inches. In other embodiments, the length of the connector 12 in the longitudinal direction may be less than 4 inches or greater than 8 inches, up to the length of the track 18. In one embodiment, the length of the connector 12 is substantially equal to the length in the same direction of the object 16 being attached to the mount 14. As illustrated, the connector 12 has a general “dumbbell” shape, but that is not intended to be limiting and the connector 12 may have any other construction or configuration.

In operation, the mount 14 is connected to a track 58 or 60 as described above. Then, one cylindrical end portion 20 is slid into the tubular connector receiving portion 36 of the mount 30. In some embodiments, the end portion 20 may have a bore 23 passing therethrough for reception of a bolt 24. After passing through the bore 23, the bolt 24 may have a threaded end that is received by a threaded hole 39 in order to hold the connector 12 in place in the longitudinal direction. The bolt 24 may be fastened to the surface 37 and/or hole 39 by alternative methods, such as by a locking pin, clamp, welding, or other suitable method. Alternatively, the connector receiving portion 36 may have no end surface 37 and the bolt 24 may be secured by a nut, snap-on ring, retaining clip, or other device to prevent the bolt 24 from slipping out of the bore 23.

Accordingly, the connector 12 is free to rotate within the connector receiving portion 36 around an axis generally parallel to the longitudinal axis of the rail, as shown in FIG. 5. The bolt 24 may move with the connector 12, or the connector 12 may move about the bolt 24. The freedom of rotation of the connector 12 may only be limited by the range of motion of the flange 28 within the width of the cutaway or slit 35.

With the connector 12 in place in the connector receiving portion 36 on the frame 30, the object 16 may then be slid onto the connector 12 such that the tubular connector receiving portion 50 receives the cylindrical connector end portion 22. In some embodiments, the end portion 22 may have a bore 23 passing therethrough for reception of a bolt 26. After passing through the bore 23, the bolt 26 may have a threaded end that is received by a threaded hole 53 (see FIG. 7) in end surface 51 in order to hold the connector 12 in place in the longitudinal direction. The bolt 26 may be fastened to the surface 51 and/or hole 53 by alternative methods, such as by a locking pin, clamp, welding, or other suitable means. Alternatively, the connector receiving portion 50 may have no end surface 51 and the bolt 26 may be secured by a nut, snap-on ring, retaining clip, or other device to prevent the bolt 26 from slipping out of the bore 23.

Accordingly, the connector 12 is free to rotate within the connector receiving portion 50 around an axis generally parallel to the longitudinal axis of the rail, as shown in FIG. 5. If a bolt 26 is used, it may move with the connector 12, or the connector 12 may move about the bolt 26. The freedom of rotation of the connector 12 may only be limited by the range of motion of the flange 28 within the width of the cutaway or slit 49.

While the invention has been described as attaching the connector 12 to the mount 14 prior to connection to the object 16, one of skill in the art will appreciate that the connector 12 may first be connected to the object 16 and then, together with the object 16, be connected to the mount 14. In a further embodiment, the connector 12 may be attached to the mount 14 and the object 16, in any order, prior to attachment of the mount 14 onto the rail 18. Such an embodiment may be utilized with a transversely attaching mount 14 or a longitudinally (sliding) attaching mount 14. Various other steps and modifications may be made as recognized by those skilled in the art without departing from the scope of the invention.

Attaching an object in the manner described herein yields the advantageous results of negating, or compensating for, the horizontal or lateral forces that may lead to binding when installing sliding accessories onto a track. For example, a truck bed accessory designed to be slid onto opposing rails 18 on left and right side panels 110 (see FIG. 8) may incur prohibitive binding effects if the rails 18 are not parallel or if a sliding force is not applied evenly. That is, because the hinged movement will accommodate some lateral movement of object 16, it will prevent such movement from applying a moment to frame 30 which may cause binding of the frame 30 on the rail. Thus, the forces at the frame/rail interface can be kept essentially vertical, which permits better sliding.

In accordance with the present invention, the problem may be solved by using a conventional non-hinged sliding attachment on one side 110 while using the dual hinge mounting assembly described herein on the other side. In this manner, any inconsistencies in the parallelism of the tracks may be compensated for by the free movement of the connector 12. Likewise, an application of an uneven sliding force is also compensated for by the free movement of the connector 12.

One of skill in the art will appreciate that compensation for uneven tracks and for an uneven application of force may be enhanced in certain applications if the length of the connector 12 is minimized and by using a plurality of connectors 12. In such an arrangement, the plurality of relatively short connectors allow some movement of the accessory or object about a rotational axis in the vertical direction (in the perspective of the Figures), thereby further reducing binding effects by providing an additional compensated degree of movement.

In another embodiment, a suitably strong but somewhat flexible material may be used for the connector 12 or for the flange 28 only to allow movement of the accessory or object about a rotational axis in the vertical direction (in the perspective of the Figures). Such a flexible connector may be formed of, for example, rubber, that may be molded in or otherwise attached to the end portions 20, 22. This embodiment may also further reduce binding effects by providing an additional compensated degree of movement.

In another embodiment of the present invention, the structure of the connector 12 and the respective connector receiving portions 36 and 50 may be reversed such that the connector receiving portions 36, 50 are constructed as generally cylindrically shaped and end portions of the connector 12 are constructed as generally tubular or C-shaped. Along these lines, one of the connector receiving portions 36 or 50 may be C-shaped as described in previous embodiments while the other connector receiving portion 36 or 50 may be cylindrical. In this case, one end portion of the connector may be C-shaped and the other end may be cylindrical, corresponding to respective mating portions on the mount 14 and object 16.

In another embodiment of the present invention, a ball and socket type connection may be used between the connector 12 and the mount 14 and/or between the connector 12 and the object 16. In such an arrangement, additional degrees of movement are provided such that some longitudinal forces are offset or compensated in addition to lateral forces.

It should be understood that any directional references (e.g., up, down, top, bottom, left, right, etc.) have been used for convenience and with reference to the accompanying Figures. These should not be regarded as limiting. The invention and/or any embodiment thereof may be practiced in various orientations, and no particular directions are essential.

While specific embodiments have been described above, it will be appreciated that the subject of the present disclosure may be practiced otherwise than as described. The descriptions above are intended to be illustrative, not limiting. Thus, it will be apparent to one skilled in the art that modifications may be made without departing from the scope of the claims set out below.

What is claimed is:

1. A mounting assembly for attaching an object to a rail, the rail having a longitudinal axis, the mounting assembly comprising:
a mount configured to mount to the rail for longitudinal movement along the rail, the mount having a first connector receiving portion;
an object having a second connector receiving portion; and
a connector having a first end portion configured to be pivotally received by the first connector receiving portion and to pivot, with respect to the mount, about an axis essentially parallel to the longitudinal axis of the rail, the connector further having a second end portion configured to be pivotally received by the second connector receiving portion and to pivot, with respect to the object, about an axis essentially parallel to the longitudinal axis of the rail,
wherein the connector is free to pivot such that, within a range of motion, lateral movement of the object transfers substantially no lateral forces to the mount.

2. The mounting assembly of claim 1, wherein the first end portion and the second end portion of the connector are cylindrically shaped and the first connector receiving portion and the second connector receiving portion are generally C-shaped so that the end portions may be slid into the connector receiving portions in a direction parallel to the longitudinal axis of the rail.

3. The mounting assembly of claim 2, wherein the first connector receiving portion comprises an end wall, the end wall being configured to receive a bolt passing through a bore in the first end portion of the connector.

4. The mounting assembly of claim 2, wherein the second connector receiving portion comprises an end wall, the end wall being configured to receive a bolt passing through a bore in the first end portion of the connector.

5. The mounting assembly of claim 1, wherein the mount includes a liner and a locking mechanism.

6. The mounting assembly of claim 1, wherein the first end portion and the second end portion are cylindrical and the connector further comprises a flange connecting the first end portion and the second end portion.

7. The mounting assembly of claim 6, wherein the flange is formed of a flexible material.

8. The mounting assembly of claim 1, wherein the object is an accessory mounting bracket.

9. The mounting assembly of claim 1, wherein the object is an accessory.

10. The mounting assembly of claim 1, further comprising:
one or more additional connectors, each connector comprising:
a first end portion configured to be received by the first connector receiving portion and to rotate, with respect to the mount, about an axis substantially parallel to the longitudinal axis of the rail; and
a second end portion configured to be received by the second connector receiving portion and to rotate, with respect to the object, about an axis substantially parallel to the longitudinal axis of the rail.

11. A method for attaching an object to a rail having a longitudinal axis comprising:
mounting a mount to a rail, the mount having a first connector receiving portion;
sliding a first end portion of a connector into the first connector receiving portion; and
sliding a second end portion of the connector into a second connector receiving portion attached to the object,
wherein the connector is free to pivot relative to the mount and relative to the object, within a range, about an axis essentially parallel to the longitudinal axis of the rail.

12. The method of claim 11, wherein the first end portion and the second end portion of the connector are cylindrically shaped and the first connector receiving portion and the second connector receiving portion are tubular.

13. The method of claim 12, wherein the first connector receiving portion comprises an end surface, the end surface being configured to receive a bolt passing through a bore in the first end portion of the connector.

14. The method of claim 12, wherein the second connector receiving portion comprises an end surface, the end surface being configured to receive a bolt passing through a bore in the first end portion of the connector.

15. The method of claim 11, wherein the mount includes a liner and a locking mechanism.

16. The method of claim 11, wherein the first end portion and the second end portion are cylindrical and the connector further comprises a flange connecting the first end portion and the second end portion.

17. The method of claim 16, wherein the flange is formed of a flexible material.

18. The method of claim 11, wherein the object is an accessory mounting bracket.

19. The method of claim 11, wherein the object is an accessory.

20. A system for attaching an object between a pair of rails, the rails having essentially parallel longitudinal axes, the system comprising:
an object;
a first mounting assembly comprising:
(i) a first mount configured to mount to a first of the rails for longitudinal movement along the first rail, the first mount being connected to a first lateral side of the object;
a second mounting assembly comprising:
(i) a second mount configured to mount to a second of the rails for longitudinal movement along the second rail, the second mount having a first connector receiving portion;
(ii) a second connector receiving portion connected to a second lateral side of the object;
(iii) a connector having a first end portion configured to be pivotally received by the first connector receiving portion and to pivot, with respect to the second mount, about an axis essentially parallel to the rails, the connector further having a second end portion configured to be pivotally received by the second connector receiving portion and to pivot, with respect to the object, about an axis essentially parallel to the axes of the rails,
wherein the connector is free to pivot such that, within a range of motion, lateral movement of the object transfers substantially no lateral forces to the second mount.

21. The system of claim 20, wherein the first mounting assembly connects to the object substantially rigidly.

22. The system of claim 20, wherein the first mount has a third connector receiving portion and the first mounting assembly further comprises:
a fourth connector receiving portion connected to the first lateral side of the object;
a second connector having a first end portion configured to be pivotally received by the third connector receiving portion and to pivot, with respect to the first mount, about an axis essentially parallel to the rails, the second connector further having a second end portion configured to be pivotally received by the fourth connector receiving portion and to pivot, with respect to the object, about an axis essentially parallel to the axes of the rails,
wherein the second connector is free to pivot such that, within a range of motion, lateral movement of the object transfers substantially no lateral forces to the first mount.

23. A mounting assembly for attaching an object to a rail, the rail having a longitudinal axis, the mounting assembly comprising:
a mount configured to mount to the rail, the mount having a first connector receiving portion;
an object having a second connector receiving portion; and
a connector having a first end portion configured to be received by the first connector receiving portion and a second end portion configured to be received by the second connector receiving portion,
wherein the connector is constructed to permit lateral movement between the mount and the object within a range of motion such that the object transfers substantially no lateral forces to the mount.
